(19) United States
(12) Patent Application Publication
(10) Pub. No.: US 2018/0049255 A1
(43) Pub. Date: Feb. 15, 2018

(54) Device and Method of Handling a Signaling Radio Bearer for Narrowband Internet of Things Communication

(71) Applicant: HTC Corporation, Taoyuan City (TW)

(72) Inventor: Te-Ming Chen, Taoyuan City (TW)

(21) Appl. No.: 15/671,154

(22) Filed: Aug. 8, 2017

Related U.S. Application Data
(60) Provisional application No. 62/373,331, filed on Aug. 10, 2016.

(51) Int. Cl. H04W 76/02; H04W 72/02

(52) U.S. Cl. CPC H04W 76/022; H04W 72/02; H04W 84/02

(57) ABSTRACT

A communication device for handling a signaling radio bearer (SRB) for a narrowband internet of things (NB-IoT) communication comprises a storage device for storing instructions and a processing circuit coupled to the storage device. The processing circuit is configured to execute the instructions stored in the storage device. The instructions comprise receiving a RRCConnectionReconfiguration-NB message from a network, when the communication device is in a RRC_CONNECTED mode, wherein the RRCConnectionReconfiguration-NB message indicates a first full configuration and comprises a first SRB configuration; and applying a default SRB configuration, a default RLC configuration and a default logical channel configuration for a SRB 1 (SRB1) according to the SRB configuration, when receiving the RRCConnectionReconfiguration-NB message.

### CROSS REFERENCE TO RELATED APPLICATIONS

This application claims the benefit of U.S. Provisional Application No. 62/373,331 filed on Aug. 10, 2016, which is incorporated herein by reference.

### BACKGROUND OF THE INVENTION

### 1. Field of the Invention

The present invention relates to a device and a method used in a wireless communication system, and more particularly, to a device and a method of handling a signaling radio bearer for a narrowband Internet of Things (NB-IoT) communication.

### 2. Description of the Prior Art

In a long-term evolution (LTE) system, a radio access network known as an evolved universal terrestrial radio access network (E-UTRAN) includes at least one evolved Node-B (eNB) for communicating with a user equipment (UE), and for communicating with a core network. The core network may include mobility management and Quality of Service (QoS) control for the UE.

### SUMMARY OF THE INVENTION

The present invention therefore provides a communication device and method for handling a signaling radio bearer for a narrowband Internet of Things (NB-IoT) communication to specify undefined operations of the NB-IoT communication.

A communication device for handling a signaling radio bearer (SRB) for a narrowband internet of things (NB-IoT) communication comprises a storage device for storing instructions and a processing circuit coupled to the storage device. The processing circuit is configured to execute the instructions stored in the storage device.

The instructions comprise receiving a RRCConnectionReconfiguration-NB message from a network, when the communication device is in a RRC_CONNECTED mode, wherein the RRCConnectionReconfiguration-NB message indicates a first full configuration and comprises a first SRB configuration; and applying a default SRB configuration, a default RLC configuration and a default logical channel configuration for a SRB 1 (SRB1) according to the SRB configuration, when receiving the RRCConnectionReconfiguration-NB message.

A communication device for handling a signaling radio bearer (SRB) for a narrowband internet of things (NB-IoT) communication comprises a storage device for storing instructions and a processing circuit coupled to the storage device. The processing circuit is configured to execute the instructions stored in the storage device. The instructions comprise receiving a RRC connection reconfiguration message from a network, when the communication device is in a RRC_CONNECTED mode, wherein the RRC connection reconfiguration message indicates a full configuration and comprises a SRB configuration; checking whether there is any srb-Identity value comprised in the SRB configuration or not, after receiving the RRC connection reconfiguration message; applying a default SRB configuration, a default RLC configuration and a default logical channel configuration for at least one SRB according to at least one srb-Identity value in the SRB configuration, when there is the at least one srb-Identity value comprised in the SRB configuration; and applying the default SRB configuration, the default RLC configuration and the default logical channel configuration for a SRB1, when there is no srb-Identity value comprised in the SRB configuration.

A communication device for handling a signaling radio bearer (SRB) for a narrowband internet of things (NB-IoT) communication comprises a storage device for storing instructions and a processing circuit coupled to the storage device. The processing circuit is configured to execute the instructions stored in the storage device.

The instructions comprise receiving a RRC connection reconfiguration message from a network, when the communication device is in a RRC_CONNECTED mode, wherein the RRC connection reconfiguration message indicates a full configuration and comprises a SRB configuration; checking whether the SRB configuration is a srb-ToAddModList or a srb-ToAddModList-NB, after receiving the RRC connection reconfiguration message; applying a default SRB configuration, a default RLC configuration and a default logical channel configuration for at least one SRB according to at least one srb-Identity value in the SRB configuration, if the SRB configuration is the srb-ToAddModList; and applying the default SRB configuration, the default RLC configuration and the default logical channel configuration for a SRB1, if the SRB configuration is the srb-ToAddModList-NB.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

FIG. 5 is a flowchart of a process according to an example of the present invention.

FIG. 6 is a flowchart of a process according to an example of the present invention.

### DETAILED DESCRIPTION

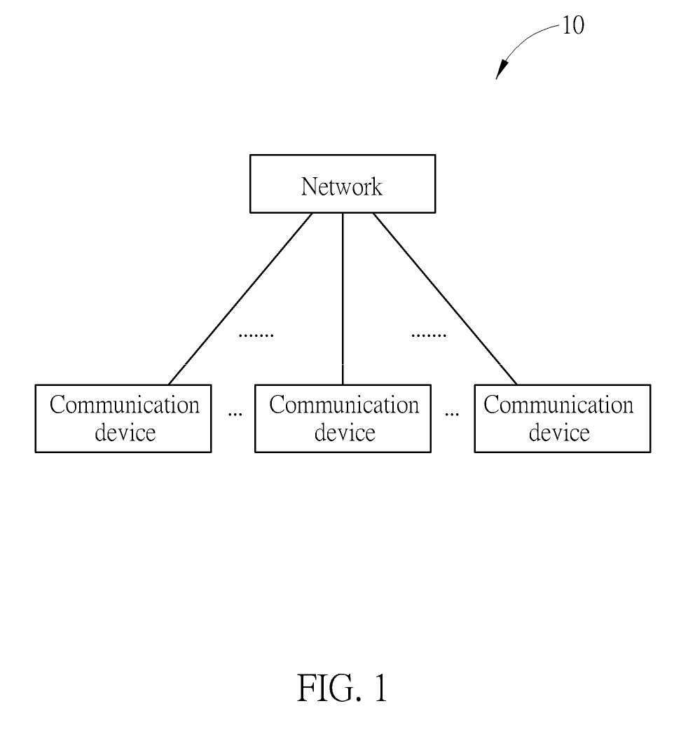

FIG. 1 is a schematic diagram of a wireless communication system 10 according to an example of the present invention. The wireless communication system 10 is briefly composed of a network and a plurality of communication devices. The network and a communication device communicate with each other via one or more cells on one or more carriers of licensed band(s) and/or unlicensed band(s). The one or more cells may be operated in the same or different frame structure types, or in the same or different duplexing modes, i.e. frequency-division duplexing (FDD) and time-division duplexing (TDD).

In FIG. 1, the network and the communication devices are simply utilized for illustrating the structure of the wireless communication system 10. The network may include a radio access network (RAN) including at least one base station (BS). Practically, the RAN may be an evolved universal terrestrial radio access network (E-UTRAN) including at least one evolved Node-B (eNB). The RAN may be a fifth generation (5G) network including at least one 5G BS (e.g., gNB) which employs orthogonal frequency-division multiplexing (OFDM) and/or non-OFDM and a transmission time interval (TTI) shorter than 1 ms (e.g. 100 or 200 microseconds), to communicate with the communication devices. In general, a BS may also be used to refer any of the eNB and the 5G BS. Furthermore, the network may also include a core network which includes network entities connecting to the RAN.

A communication device may be a user equipment (UE), a narrowband Internet of Things (NB-IoT) UE, a machine type communication (MTC) device, a mobile phone, a laptop, a tablet computer, an electronic book, a portable computer system, a vehicle, or an aircraft. In addition, the network and the communication device can be seen as a transmitter or a receiver according to direction (i.e., transmission direction), e.g., for an uplink (UL), the communication device is the transmitter and the network is the receiver, and for a downlink (DL), the network is the transmitter and the communication device is the receiver.

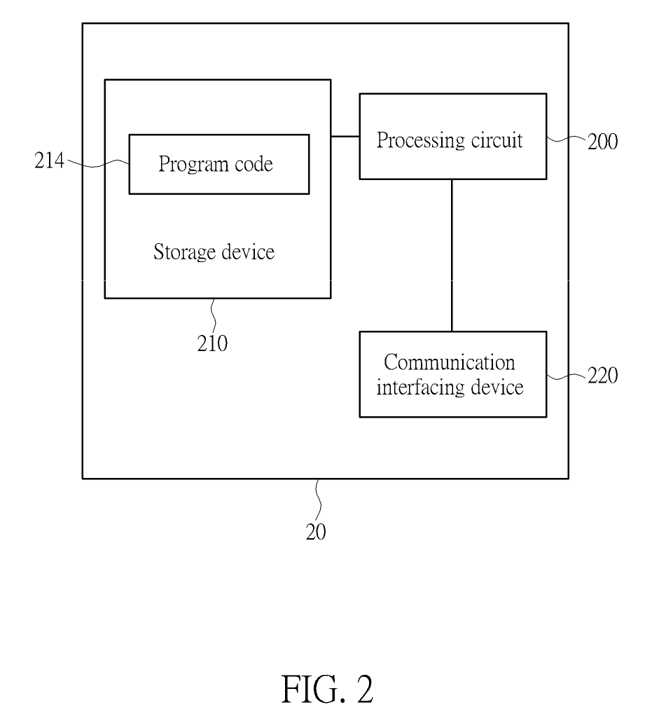

FIG. 2 is a schematic diagram of a communication device 20 according to an example of the present invention. The communication device 20 may be a communication device or the network shown in FIG. 1, but is not limited herein. The communication device 20 may include a processing circuit 200 such as a microprocessor or Application Specific Integrated Circuit (ASIC), a storage device 210 and a communication interfacing device 220. The storage device 210 may be any data storage device that may store a program code 214, accessed and executed by the processing circuit 200. Examples of the storage device 210 include but are not limited to a subscriber identity module (SIM), read-only memory (ROM), flash memory, random-access memory (RAM), hard disk, optical data storage device, non-volatile storage device, non-transitory computer-readable medium (e.g., tangible media), etc. The communication interfacing device 220 includes a transceiver and is used to transmit and receive signals (e.g., data, messages and/or packets) according to processing results of the processing circuit 200.

In the following embodiments, a UE is used to represent a communication device in FIG. 1, to simplify the illustration of the embodiments.

A scenario assumed according to an example of the present invention is stated as follows. After receiving a RRC connection reconfiguration message from an eNB and a fullConfig is set to TRUE, the UE applies default radio resource configurations. Based on a srb-Identity value included in a receiving srb-ToAddModList, the UE reconfigures corresponding signalling radio bearers (SRBs) to default values. However, the situation is different for a narrowband Internet of Things (NB-IoT) communication. The eNB does not include any srb-Identity value in a srb-ToAddModList-NB for a NB-IoT UE. Accordingly, the NB-IoT UE does not know how to operate, after receiving a RRC connection reconfiguration message for a full configuration. Thus, operations of the NB-IoT UE should be defined.

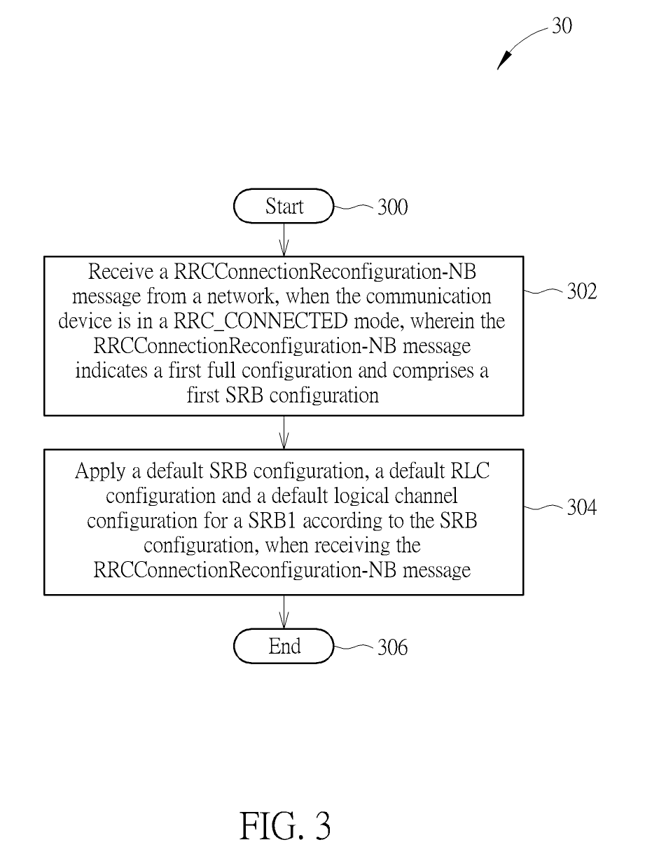

FIG. 3 is a flowchart of a process 30 according to an example of the present invention. The process 30 may be utilized in a UE to communicate with a BS (e.g., in the network in FIG. 1), and includes the following steps:

Step 300: Start.

Step 302: Receive a RRCConnectionReconfiguration-NB message from a network, when the communication device is in a RRC CONNECTED mode, wherein the RRCConnectionReconfiguration-NB message indicates a first full configuration and comprises a first SRB configuration.

Step 304: Apply a default SRB configuration, a default RLC configuration and a default logical channel configuration for a SRB 1 (SRB1) according to the SRB configuration, when receiving the RRCConnectionReconfiguration-NB message.

Step 306: End.

According to the process 30, a UE in RRC CONNECTED mode receives a RRCConnectionReconfiguration-NB message from a network. The RRCConnectionReconfiguration-NB message may indicate a first full configuration (e.g., the RRCConnectionReconfiguration-NB message includes fullConfig set to TRUE), and may comprise a first SRB configuration (e.g., srb-ToAddModList-NB). It should be noted that the SRB configuration may not include a SRB identity (e.g., srb-ToAddModList-NB does not include a srb-Identity). When receiving the RRCConnectionReconfiguration-NB message from the network, the UE applies a default SRB configuration, a default RLC configuration and a default logical channel configuration for a SRB1.

In one example, the UE receives a RRCConnectionReconfiguration message from the network. The RRCConnectionReconfiguration message indicates a second full configuration (e.g., the RRCConnectionReconfiguration message includes a “fullConfig” set to TRUE), and includes a second SRB configuration (e.g., srb-ToAddModList), wherein the second SRB configuration includes at least one SRB identity (e.g., srb-ToAddModList includes at least one srb-Identity). According to the at least one SRB identity included in the second SRB configuration, the UE applies the default SRB, the default RLC and the default logical channel configuration for at least one SRB (e.g., which is corresponding to the at least one SRB identity).

In one example, the UE is a NB-IoT UE or a LTE UE that supports at least one NB-IoT capability. In one example, the UE further applies the default SRB configuration, the default RLC configuration and the default logical channel configuration for all SRBs supported by the UE.

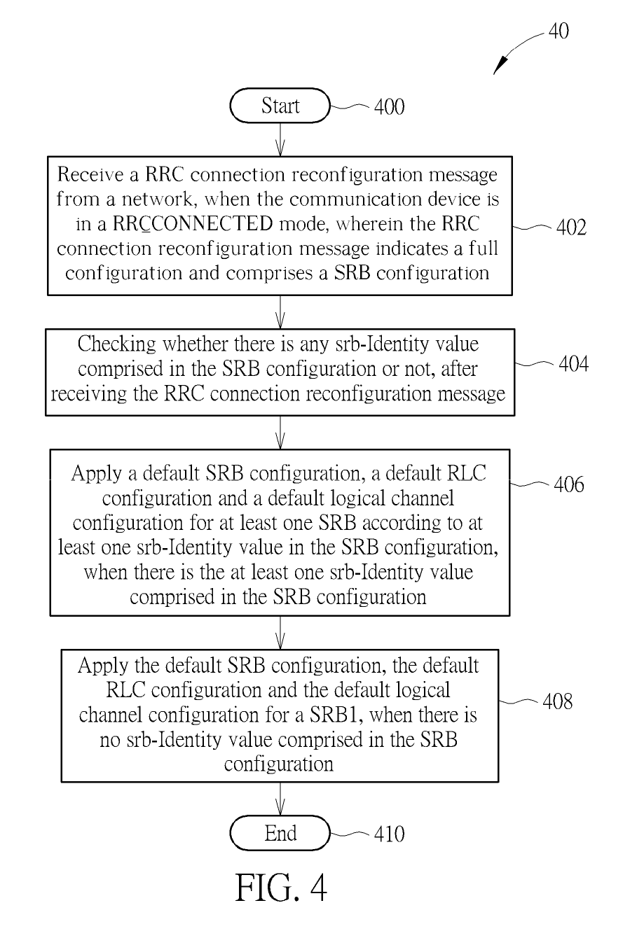

FIG. 4 is a flowchart of a process 40 according to an example of the present invention. The process 40 may be utilized in a UE to communicate with a BS (e.g., in the network in FIG. 1), and includes the following steps:

Step 400: Start.

Step 402: Receive a RRC connection reconfiguration message from a network, when the communication device is in a RRC CONNECTED mode, wherein the RRC connection reconfiguration message indicates a full configuration and comprises a SRB configuration.

Step 404: Checking whether there is any srb-Identity value comprised in the SRB configuration or not, after receiving the RRC connection reconfiguration message.

Step 406: Apply a default SRB configuration, a default RLC configuration and a default logical channel configuration for at least one SRB according to at least one srb-Identity value in the SRB configuration, when there is the at least one srb-Identity value comprised in the SRB configuration.

Step 408: Apply the default SRB configuration, the default RLC configuration and the default logical channel configuration for a SRB1, when there is no srb-Identity value comprised in the SRB configuration.

Step 410: End.

According to the process 40, a UE in a RRC CONNECTED mode receives a RRC connection reconfiguration message from a network. The RRC connection reconfiguration message may indicate a full configuration (e.g., the RRC connection reconfiguration message includes a “fullConfig” set to TRUE), and may comprise a SRB configuration. After receiving the RRC connection reconfiguration message from the network, the UE checks whether there is any srb-Identity value comprised in the SRB configuration or not. When there is at least one srb-Identity value comprised in the SRB configuration, the UE applies a default SRB configuration, a default RLC configuration and a default logical channel configuration for at least one SRB according to (e.g., corresponding to) the at least one srb-Identity value. When there is no srb-Identity value in the SRB configuration, the UE applies the default SRB configuration, the default RLC configuration and the default logical channel configuration for a SRB1.

In one example, the RRC connection reconfiguration message is a RRCConnectionReconfiguration message or a RRCConnectionReconfiguration-NB message. In one example, the SRB configuration is a srb-ToAddModList or a srb-ToAddModList-NB. In one example, the UE is a NB-IoT UE or a LTE UE that supports at least one NB-IoT capability. In one example, the UE further applies the default SRB configuration, the default RLC configuration and the default logical channel configuration for all SRBs supported by the UE.

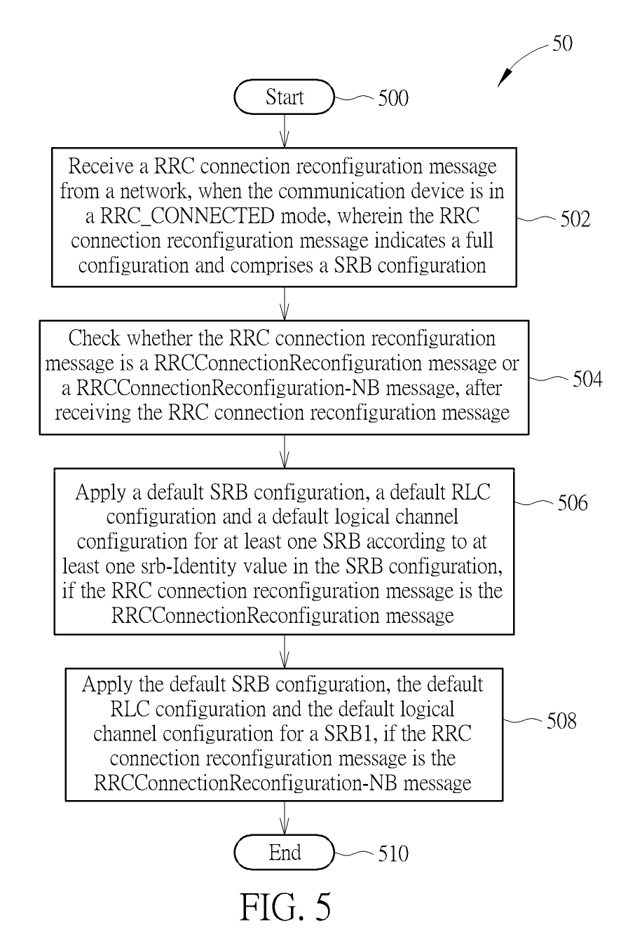

FIG. 5 is a flowchart of a process 50 according to an example of the present invention. The process 50 may be utilized in a UE to communicate with a BS (e.g., in the network in FIG. 1), and includes the following steps:

Step 500: Start.

Step 502: Receive a RRC connection reconfiguration message from a network, when the communication device is in a RRC_CONNECTED mode, wherein the RRC connection reconfiguration message indicates a full configuration and comprises a SRB configuration.

Step 504: Check whether the RRC connection reconfiguration message is a RRCConnectionReconfiguration message or a RRCConnectionReconfiguration-NB message, after receiving the RRC connection reconfiguration message.

Step 506: Apply a default SRB configuration, a default RLC configuration and a default logical channel configuration for at least one SRB according to at least one srb-Identity value in the SRB configuration, if the RRC connection reconfiguration message is the RRCConnectionReconfiguration message.

Step 508: Apply the default SRB configuration, the default RLC configuration and the default logical channel configuration for a SRB1, if the RRC connection reconfiguration message is the RRCConnectionReconfiguration-NB message.

Step 510: End.

According to the process 50, a UE in a RRC CONNECTED mode receives a RRC connection reconfiguration message from the network. The RRC connection reconfiguration message indicates a full configuration (e.g., the message comprises a “fullConfig” set to TRUE), and comprises a SRB configuration. After receiving the RRC connection reconfiguration message from the network, the UE checks whether the RRC connection reconfiguration message is a RRCConnectionReconfiguration message or a RRCConnectionReconfiguration-NB message. If the RRC connection reconfiguration message is the RRCConnectionReconfiguration message, the UE applies a default SRB configuration, a default RLC configuration and a default logical channel configuration for at least one SRB according to (e.g., corresponding to) at least one srb-Identity value in the SRB configuration. If the RRC connection reconfiguration message is the RRCConnectionReconfiguration-NB message, the UE applies the default SRB configuration, the default RLC configuration and the default logical channel configuration for a SRB1.

In one example, the UE is a NB-IoT UE or a LTE UE that supports at least one NB-IoT capability. In one example, the UE further applies the default SRB configuration, the default RLC configuration and the default logical channel configuration for all SRBs supported by the UE. In one example, the SRB configuration is a srb-ToAddModList or a srb-ToAddModList-NB.

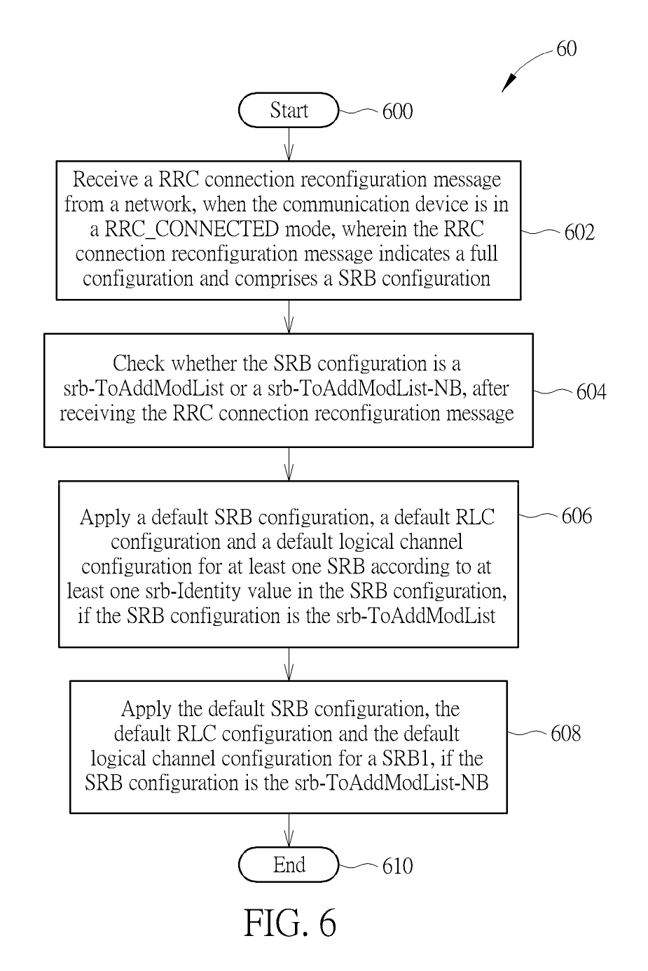

FIG. 6 is a flowchart of a process 60 according to an example of the present invention. The process 60 may be utilized in a UE to communicate with a BS (e.g., in the network in FIG. 1), and includes the following steps:

Step 600: Start.

Step 602: Receive a RRC connection reconfiguration message from a network, when the communication device is in a RRC CONNECTED mode, wherein the RRC connection reconfiguration message indicates a full configuration and comprises a SRB configuration.

Step 604: Check whether the SRB configuration is a srb-ToAddModList or a srb-ToAddModList-NB, after receiving the RRC connection reconfiguration message.

Step 606: Apply a default SRB configuration, a default RLC configuration and a default logical channel configuration for at least one SRB according to at least one srb-Identity value in the SRB configuration, if the SRB configuration is the srb-ToAddModList.

Step 608: Apply the default SRB configuration, the default RLC configuration and the default logical channel configuration for a SRB1, if the SRB configuration is the srb-ToAddModList-NB.

Step 610: End.

According to the process 60, a UE in a RRC CONNECTED mode receives a RRC connection reconfiguration message from a network. The RRC connection reconfiguration message indicates a full configuration (e.g., the message including a “fullConfig” set to TRUE), and comprises a SRB configuration. After receiving the RRC connection reconfiguration message from the network, the UE checks whether the SRB configuration is a srb-ToAddModList or a srb-ToAddModList-NB. If the SRB configuration is the srb-ToAddModList, the UE applies a default SRB configuration, a default RLC configuration and a default logical channel configuration for at least one SRB according to (e.g., corresponding to) at least one srb-Identity value in the SRB configuration. If the SRB configuration is the srb-ToAddModList-NB, the UE applies the default SRB configuration, the default RLC configuration and the default logical channel configuration for a SRB1.

In one example, the UE is a NB-IoT UE or a LTE UE that supports at least one NB-IoT capability. In one example, the UE further applies the default SRB configuration, the default RLC configuration and the default logical channel configuration for all SRBs supported by the UE. In one example, the RRC connection reconfiguration message is a RRCConnectionReconfiguration message or a RRCConnectionReconfiguration-NB message.

Examples for illustrating correspondence between srb-Identity value(s) and SRB(s) in at least one of the process 40, 50 and 60 are described as follows. In one example, if the srb-Identity value is 2, the UE applies the default SRB configuration, the default RLC configuration and the default logical channel configuration for a SRB 2 (SRB2). In one example, if the SRB configuration includes a first srb-Identity value which is 1 and a second srb-Identity value which is 2, the UE applies the default SRB configuration, the default RLC configuration and the default logical channel configuration for the SRB1 and the SRB2.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20. Any of the above processes and examples above may be compiled into the program code 214.

To sum up, the present invention provides a device and a method for handling a NB-IoT communication. Correct operations can be performed after receiving a RRC connection reconfiguration message. Thus, the problem in the art is solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for handling a signaling radio bearer (SRB) for a narrowband internet of things (NB-IoT) communication, comprising:
a storage device, for storing instructions of:
receiving a RRCConnectionReconfiguration-NB message from a network, when the communication device is in a RRC CONNECTED mode, wherein the RRCConnectionReconfiguration-NB message indicates a first full configuration and comprises a first SRB configuration; and
applying a default SRB configuration, a default RLC configuration and a default logical channel configuration for a SRB 1 (SRB1) according to the SRB configuration, when receiving the RRCConnectionReconfiguration-NB message; and
a processing circuit, coupled to the storage device, configured to execute the instructions stored in the storage device.

2. The communication device of claim 1, wherein the storage device further stores the instruction of:
receiving a RRCConnectionReconfiguration message from the network, when the communication device is in the RRC CONNECTED mode, wherein the RRCConnectionReconfiguration message indicates a second full configuration and comprises a second SRB configuration comprising at least one SRB identity; and
applying the default SRB configuration, the default RLC configuration and the default logical channel configuration for at least one SRB according to the at least one SRB identity.

3. The communication device of claim 1, wherein the communication device supports at least one NB-IoT capability.

4. The communication device of claim 1, wherein the storage device further stores the instruction of:
applying the default SRB configuration, the default RLC configuration and the default logical channel configuration for all SRBs supported by the communication device.

5. A communication device for handling a signaling radio bearer (SRB) for a narrowband internet of things (NB-IoT) communication, comprising:
a storage device, for storing instructions of:
receiving a RRC connection reconfiguration message from a network, when the communication device is in a RRC CONNECTED mode, wherein the RRC connection reconfiguration message indicates a full configuration and comprises a SRB configuration;
checking whether there is any srb- Identity value comprised in the SRB configuration or not, after receiving the RRC connection reconfiguration message;
applying a default SRB configuration, a default RLC configuration and a default logical channel configuration for at least one SRB according to at least one srb-Identity value in the SRB configuration, when there is the at least one srb-Identity value comprised in the SRB configuration; and
applying the default SRB configuration, the default RLC configuration and the default logical channel configuration for a SRB1, when there is no srb-Identity value comprised in the SRB configuration; and
a processing circuit, coupled to the storage device, configured to execute the instructions stored in the storage device.

6. The communication device of claim 5, wherein the RRC connection reconfiguration message is a RRCConnectionReconfiguration message or a RRCConnectionReconfiguration-NB message.

7. The communication device of claim 5, wherein the SRB configuration is a srb-ToAddModList or a srb-ToAddModList-NB.

8. The communication device of claim 5, wherein the communication device supports at least one NB-IoT capability.

9. The communication device of claim 5, wherein the storage device further stores the instruction of:
applying the default SRB configuration, the default RLC configuration and the default logical channel configuration for all SRBs supported by the communication device.

10. A communication device for handling a signaling radio bearer (SRB) for a narrowband internet of things (NB-IoT) communication, comprising:
a storage device, for storing instructions of:
receiving a RRC connection reconfiguration message from a network, when the communication device is in a RRC CONNECTED mode, wherein the RRC connection reconfiguration message indicates a full configuration and comprises a SRB configuration;
checking whether the SRB configuration is a srb-ToAddModList or a srb-ToAddModList-NB, after receiving the RRC connection reconfiguration message;
applying a default SRB configuration, a default RLC configuration and a default logical channel configuration for at least one SRB according to at least one srb-Identity value in the SRB configuration, if the SRB configuration is the srb-ToAddModList; and
applying the default SRB configuration, the default RLC configuration and the default logical channel configuration for a SRB1, if the SRB configuration is the srb-ToAddModList-NB; and
a processing circuit, coupled to the storage device, configured to execute the instructions stored in the storage device.

11. The communication device of claim 10, wherein the RRC connection reconfiguration message is a RRCConnectionReconfiguration message or a RRCConnectionReconfiguration-NB message.

12. The communication device of claim 10, wherein the communication device supports at least one NB-IoT capability.

13. The communication device of claim 10, wherein the storage device further stores the instruction of:
applying the default SRB configuration, the default RLC configuration and the default logical channel configuration for all SRBs supported by the communication device.
